(19) United States
(12) Patent Application Publication
(10) Pub. No.: US 2026/0311528 A1
(43) Pub. Date: Oct. 8, 2026

(54) BLE-Based Automatic Unlocking Method for Smart Lock

(71) Applicant: XTHINGS INDUSTRY LLC, Fremont, CA (US)

(72) Inventor: CHENGLIN QIU, Shanghai (CN)

(73) Assignee: XTHINGS INDUSTRY LLC, Fremont, CA (US)

(21) Appl. No.: 19/569,944

(22) Filed: Mar. 17, 2026

(51) Int. Cl. G07C 9/00; H04W 4/80

(52) U.S. Cl. CPC G07C 9/00309; H04W 4/80; G07C 2209/63

(57) ABSTRACT

The present invention relates to the field of smart lock communication technology, specifically to a BLE-based automatic unlocking method for a smart lock. By arranging a BLE module and configuring its electronic fence within the smart lock, the present invention establishes communication linkage with a mobile phone operating system and an APP. This enables the detection of a mobile phone entering the electronic fence as a “Returning Home” state, thereby notifying the mobile phone APP to perform unlocking. Furthermore, by utilizing the BLE module to determine the relative distance between the mobile phone and the smart lock, the present invention achieves proximity-based automatic unlocking and the function of determining whether a user is inside or outside the door.

### TECHNICAL FIELD

The present invention relates to the field of smart lock communication technology, and specifically, to a Bluetooth Low Energy (BLE)-based automatic unlocking method for a smart lock.

### BACKGROUND ART

A smart lock is an upgraded form of a traditional mechanical lock. Its core concept is to replace or supplement traditional key unlocking with electronic technology, biometric technology, or wireless communication technology, thereby achieving more convenient and secure access control. Smart locks are widely used in settings such as homes, apartments, and offices.

With the continuous performance improvements of mobile phones and their operating systems, a growing number of application technologies that integrate mobile communication with living and working scenarios have been optimized accordingly. These optimizations aim to enhance user experience and promote innovative designs for a smarter lifestyle.

However, the more advanced unlocking modes for smart locks in the prior art still primarily rely on user-initiated actions, such as manually pressing a button on the smart lock or using facial recognition applications. How to further improve the intelligence of smart lock unlocking, especially in scenarios involving an independent garage or vehicle entry, remains a challenge. These situations often require additional operational steps from the user, resulting in a poor experience.

For the above reasons, the present invention designs a BLE-based automatic unlocking method for a smart lock. Building upon mutual communication between the smart lock and a mobile terminal, this method optimizes the unlocking experience based on the relative positional relationship between the user and the smart lock. This establishes a dynamic intelligent association between the smart lock and the user, providing an improved living experience and enhancing the market value of the smart lock itself.

### SUMMARY OF THE INVENTION

The objective of the present invention is to overcome the deficiencies in the prior art by providing a Bluetooth Low Energy (BLE)-based automatic unlocking method for a smart lock. Building upon mutual communication between the smart lock and a mobile terminal, this method optimizes the unlocking experience based on the relative positional relationship between the user and the smart lock. This establishes a dynamic intelligent association between the smart lock and the user, providing a better living experience and enhancing the market value of the smart lock itself.

The present invention provides a BLE-based automatic unlocking method for a smart lock, comprising the following steps:
S1, arranging a single-mode BLE chip and a Wi-Fi+BLE dual-mode chip in the smart lock;
S2, setting an electronic fence range for the single-mode BLE chip;
S3, when a mobile phone enters the electronic fence range, activating a mobile phone APP by a mobile phone operating system;
S4, the mobile phone APP scanning for the single-mode BLE chip and the Wi-Fi+BLE dual-mode chip via the mobile phone operating system;
S5, the single-mode BLE chip activating the Wi-Fi+BLE dual-mode chip, and after connecting with the mobile phone operating system, activating the mobile phone APP;
S6, the Wi-Fi+BLE dual-mode chip activating, and after connecting with the mobile phone operating system, activating the mobile phone APP;
S7, the mobile phone APP instructing the Wi-Fi+BLE dual-mode chip to unlock the door, and the Wi-Fi+BLE dual-mode chip notifying the mobile phone APP after the door is successfully unlocked;
S8, the mobile phone APP entering a dormant state until leaving the electronic fence range of the single-mode BLE chip again;
S9, when the mobile phone leaves the electronic fence range of the single-mode BLE chip, the mobile phone operating system notifying the mobile phone APP.

The single-mode BLE chip is a Telink BLE chip, and the Wi-Fi+BLE dual-mode chip is a C3 BLE chip.

The APP in S3 enters a dormant state after 10 seconds.

After the APP enters the dormant state, the operating system of the mobile phone continues to process a connection request between the APP and the single-mode BLE chip in the background, and the APP is awakened again after a successful connection.

The mobile phone operating system is an iOS system or an Android system.

For the iOS system, the electronic fence range set for the single-mode BLE chip is 200 meters; for the Android system, the electronic fence range set for the single-mode BLE chip is a maximum of 1000 meters.

Compared with the prior art, the present invention, by arranging a BLE module and its electronic fence within the smart lock, enables communication linkage with the mobile phone operating system and the APP. This allows for the detection of a mobile phone entering the electronic fence as a “returning home” state, thereby notifying the mobile phone APP to perform unlocking. Furthermore, by leveraging the capability of the BLE module to determine the relative distance between the mobile phone and the smart lock, the present invention achieves proximity-based automatic unlocking and the function of determining whether a user is inside or outside the door. This significantly enhances the smart lock's intelligent perception of user location, thereby advancing new functionalities for intelligent unlocking determination. In specific scenarios such as access control systems, villa estates, or situations where users find it inconvenient to manually unlock (e.g., while in a vehicle), the present invention provides a superior user experience and increases the product's market value.

### DESCRIPTION OF DRAWINGS

FIG. 1 is a schematic diagram illustrating the unlocking steps based on an electronic fence range according to the present invention.

FIG. 2 is a schematic timing diagram illustrating communication among the mobile phone APP, the mobile phone operating system, and the smart lock according to the present invention.

### EMBODIMENTS

The present invention is further described below with reference to the accompanying drawings.

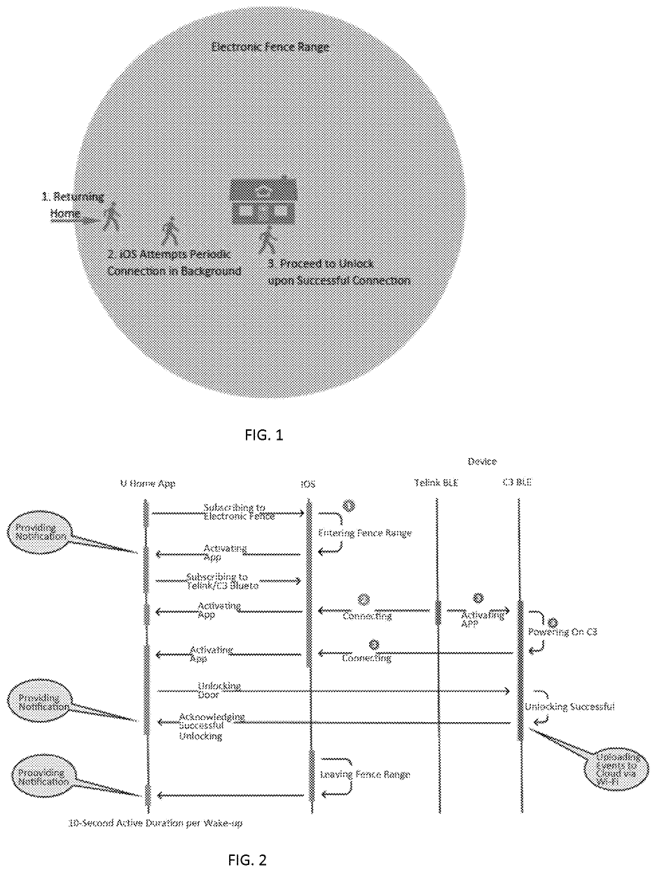

Referring to FIGS. 1-2, the present invention provides a Bluetooth Low Energy (BLE)-based automatic unlocking method for a smart lock, comprising the following steps:
S1, arranging a single-mode BLE chip and a Wi-Fi+BLE dual-mode chip in the smart lock;
S2, setting an electronic fence range for the single-mode BLE chip;
S3, when a mobile phone enters the electronic fence range, activating a mobile phone APP by a mobile phone operating system;
S4, the mobile phone APP scanning for the single-mode BLE chip and the Wi-Fi+BLE dual-mode chip via the mobile phone operating system;
S5, the single-mode BLE chip activating the Wi-Fi+BLE dual-mode chip, and after connecting with the mobile phone operating system, activating the mobile phone APP;
S6, the Wi-Fi+BLE dual-mode chip activating, and after connecting with the mobile phone operating system, activating the mobile phone APP;
S7, the mobile phone APP instructing the Wi-Fi+BLE dual-mode chip to unlock the door, and the Wi-Fi+BLE dual-mode chip notifying the mobile phone APP after the door is successfully unlocked;
S8, the mobile phone APP entering a dormant state until leaving the electronic fence range of the single-mode BLE chip again;
S9, when the mobile phone leaves the electronic fence range of the single-mode BLE chip, the mobile phone operating system notifying the mobile phone APP.

The single-mode BLE chip is a Telink BLE chip, and the Wi-Fi+BLE dual-mode chip is a C3 BLE chip.

The APP in S3 enters a dormant state after 10 seconds.

After the APP enters the dormant state, the operating system of the mobile phone continues to process a connection request between the APP and the single-mode BLE chip in the background, and the APP is awakened again after a successful connection.

The mobile phone operating system is an iOS system or an Android system.

For the iOS system, the electronic fence range set for the single-mode BLE chip is 200 meters; for the Android system, the electronic fence range set for the single-mode BLE chip is a maximum of 1000 meters.

### Working Principle:

Background Introduction: TELINK BLE and C3 BLE (ESP32-C3) represent two different design approaches for IoT chips: TELINK focuses on low power consumption and multi-protocol support, leading in battery life and protocol compatibility; whereas the C3 excels in integration and performance, offering Wi-Fi+BLE dual connectivity and powerful processing capabilities.

During use, the present invention requires the mobile phone's GPS, Bluetooth, Wi-Fi, and notification functions to be enabled. It functions only when GPS (with “always” permission), Bluetooth, and other necessary features are all activated.

As shown in FIG. 1, the electronic fence range of the present invention, configured for the Telink BLE chip, is centered on the smart lock. The radius R is 200 meters for iOS and 300 meters by default for Android (configurable for Android, with a maximum of 1000 meters). This value is related to the positioning accuracy of the mobile phone.

When returning home and entering the circular range, the status changes from “away” to “back” and a home-return notification will be received. This notification corresponds to step S3 of the present invention. When the mobile phone approaches within a certain range of the smart lock, such as within 5 meters, the smart lock will automatically unlock and issue a notification, corresponding to step S7 of the present invention. Once the automatic unlocking is completed after one home return, the method of the present invention ceases operation until the next time the user leaves the electronic fence range and the notification is triggered again. That is: when the mobile phone remains within the circular range in the figure, the system defaults to “back” mode and does not trigger any notifications. When leaving the circular range, a “leaving home” notification is triggered.

Specifically,, the relative distance and signal strength between the mobile phone and the smart lock are determined by measuring the RSSI signal between the BLE module integrated into the smart lock and the mobile phone's BLE. This is used to judge whether the user is currently inside or outside the door. If the user is determined to be inside, the system does not initiate BLE communication for door opening, thereby avoiding accidental door openings.

The above description is merely of preferred embodiments of the present invention, intended only to aid in understanding the method and its core concept of this application. The protective scope of the present invention is not limited to the above-mentioned embodiments; all technical solutions under the concept of the present invention fall within its protection scope. It should be pointed out that for those of ordinary skill in the art, several improvements and modifications made without departing from the principle of the present invention should also be regarded as falling within the protection scope of the present invention.

In the description of the present invention, it should be noted that orientation or positional relationships indicated by terms such as “upper,” “lower,” “inner,” “outer,” etc., are based on the orientation or positional relationships shown in the accompanying drawings. They are used only for convenience in describing the present invention and simplifying the description, rather than indicating or implying that the referred device or element must have a specific orientation or be constructed and operated in a specific orientation. Therefore, they should not be construed as limitations on the present invention.

On the whole, the present invention addresses the inconvenience arising from the mode in the prior art where smart locks still require manual interaction for unlocking, particularly in certain specific scenarios. By arranging a BLE chip inside the smart lock, the present invention intelligently senses the user's state upon entering the electronic fence range of the smart lock and accomplishes automatic, intelligent unlocking through real-time communication. This significantly enhances the user experience, raises the application ceiling for smart locks, and contributes to increasing the product's market value.

1. A BLE-based automatic unlocking method for a smart lock, comprising the following steps:
S1, arranging a single-mode BLE chip and a Wi-Fi+BLE dual-mode chip in the smart lock;
S2, setting an electronic fence range for the single-mode BLE chip;
S3, when a mobile phone enters the electronic fence range, activating a mobile phone APP by a mobile phone operating system;
S4, the mobile phone APP scanning for the single-mode BLE chip and the Wi-Fi+BLE dual-mode chip via the mobile phone operating system;
S5, the single-mode BLE chip activating the Wi-Fi+BLE dual-mode chip, and after connecting with the mobile phone operating system, activating the mobile phone APP;
S6, the Wi-Fi+BLE dual-mode chip activating, and after connecting with the mobile phone operating system, activating the mobile phone APP;
S7, the mobile phone APP instructing the Wi-Fi+BLE dual-mode chip to unlock the door, and the Wi-Fi+BLE dual-mode chip notifying the mobile phone APP after the door is successfully unlocked;
S8, the mobile phone APP entering a dormant state until leaving the electronic fence range of the single-mode BLE chip again; and
S9, when the mobile phone leaves the electronic fence range of the single-mode BLE chip, the mobile phone operating system notifying the mobile phone APP.

2. The BLE-based automatic unlocking method for a smart lock according to claim 1, wherein the single-mode BLE chip is a Telink BLE chip, and the Wi-Fi+BLE dual-mode chip is a C3 BLE chip.

3. The BLE-based automatic unlocking method for a smart lock according to claim 1, wherein the mobile phone APP in S3 enters a dormant state after 10 seconds.

4. The BLE-based automatic unlocking method for a smart lock according to claim 3, wherein after the APP enters the dormant state, the operating system of the mobile phone continues to process a connection request between the APP and the single-mode BLE chip in the background, and the APP is awakened again after a successful connection.

5. The BLE-based automatic unlocking method for a smart lock according to claim 1, wherein the mobile phone operating system is an iOS system or an Android system.

6. The BLE-based automatic unlocking method for a smart lock according to claim 5, wherein for the iOS system, the electronic fence range set for the single-mode BLE chip is 200 meters; for the Android system, the electronic fence range set for the single-mode BLE chip is a maximum of 1000 meters.
